(19) United States
(12) Patent Application Publication
(10) Pub. No.: US 2025/0236111 A1
(43) Pub. Date: Jul. 24, 2025

(54) INKJET CONTROL METHOD AND INKJET RECORDING APPARATUS

(71) Applicant: KYOCERA Document Solutions Inc., Osaka (JP)

(72) Inventor: Masayuki Miyake, Osaka (JP)

(21) Appl. No.: 19/021,972

(22) Filed: Jan. 15, 2025

(30) Foreign Application Priority Data
Jan. 19, 2024 (JP) 2024-006567

(51) Int. Cl. B41J 2/17; B41J 2/045; B41J 2/165; B41J 11/00; B41J 13/08

(52) U.S. Cl. CPC B41J 2/1707; B41J 2/04563; B41J 2/04566; B41J 2/04573; B41J 2/04581; B41J 2/165; B41J 11/009; B41J 13/08

(57) ABSTRACT

A processor sets, for each target sheet that becomes a target to be conveyed by a preceding conveying device, a specific number of 1 or more in accordance with an ink ejection performance of a nozzle unit obtained at a time a previous sheet that is one sheet before the target sheet is conveyed by a belt conveying device. The processor causes the nozzle unit to execute opening flushing processing for ejecting ink toward the specific number of subsequent opening portions that pass through a print position subsequent to the previous sheet out of a plurality of opening portions of a conveying belt. The processor causes the preceding conveying device to execute processing of conveying the target sheet to the belt conveying device at a timing subsequent to the specific number of the subsequent opening portions.

### INCORPORATION BY REFERENCE

This application is based upon and claims the benefit of priority from the corresponding Japanese Patent Application No. 2024-006567 filed on Jan. 19, 2024, the entire contents of which are incorporated herein by reference.

### BACKGROUND

The present disclosure relates to an inkjet control method and an inkjet recording apparatus for performing flushing control to prevent nozzles from being clogged.

An inkjet recording apparatus executes print processing for forming an image on a sheet using an inkjet system. In the inkjet recording apparatus, there is a need to prevent each of a plurality of nozzles from being clogged. For example, it is known that flushing control is performed in a case where a predetermined time has elapsed since the last print processing, and the like.

The flushing control is control for causing the inkjet recording apparatus to execute flushing processing for ejecting ink irrespective of the print processing. For example, the flushing control is executed under a situation where the plurality of nozzles are covered by a cap.

### SUMMARY

An inkjet control method according to an aspect of the present disclosure is a method of controlling an inkjet recording apparatus including a belt conveying device, a preceding conveying device, and a nozzle unit. The belt conveying device includes an endless conveying belt in which a plurality of opening portions each constituted of one or more through-holes are formed with intervals in a circumferential direction, and conveys a sheet on the conveying belt by causing the conveying belt to rotate. The preceding conveying device conveys the sheet to the belt conveying device. The nozzle unit includes a plurality of nozzles arranged opposed to a print position on an upper surface of the conveying belt and a plurality of piezoelectric elements which pressurize ink to be supplied to the plurality of nozzles to cause the ink to be ejected from the plurality of nozzles, and is capable of executing print processing for forming an image on the sheet by ejecting the ink onto the sheet conveyed on the conveying belt. The inkjet control method includes setting, by a processor, for each target sheet that becomes a target to be conveyed by the preceding conveying device, a specific number of 1 or more in accordance with an ink ejection performance of the nozzle unit obtained at a time a previous sheet that is one sheet before the target sheet is conveyed by the belt conveying device. The inkjet control method further includes causing, by the processor, the nozzle unit to execute opening flushing processing for ejecting the ink toward the specific number of subsequent opening portions that pass through the print position subsequent to the previous sheet out of the plurality of opening portions. The inkjet control method further includes causing, by the processor, the preceding conveying device to execute processing of conveying the target sheet to the belt conveying device at a timing subsequent to the specific number of the subsequent opening portions.

An inkjet recording apparatus according to another aspect of the present disclosure includes the belt conveying device, the preceding conveying device, the nozzle unit, and the processor which realizes the inkjet control method.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an inkjet recording apparatus according to an embodiment;

FIG. 2 is a cross-sectional view of an ink ejection portion of a nozzle unit in the inkjet recording apparatus according to the embodiment;

FIG. 3 is a block diagram showing a configuration of a control device in the inkjet recording apparatus according to the embodiment;

FIG. 4 is a plan view of a belt conveying device in the inkjet recording apparatus according to the embodiment;

FIG. 5 is a flowchart showing exemplary procedures of first opening flushing control in the inkjet recording apparatus according to the embodiment;

FIG. 6 is a flowchart showing exemplary procedures of sheet flushing control in the inkjet recording apparatus according to the embodiment;

FIG. 7 is a flowchart showing exemplary procedures of second opening flushing control in the inkjet recording apparatus according to the embodiment;

FIG. 8 is a plan view of the belt conveying device which conveys a sheet having a standard length; and

FIG. 9 is a plan view of the belt conveying device which conveys a sheet longer than the standard length.

### DETAILED DESCRIPTION

Hereinafter, an embodiment of the present disclosure will be described with reference to the drawings. It is noted that the following embodiment is an example of embodying the present disclosure and does not limit the technical scope of the present disclosure.

### [Configuration of Inkjet Recording Apparatus 10]

An inkjet recording apparatus 10 according to the embodiment is a printer that is capable of executing print processing using an inkjet system.

The print processing is processing of forming an image on a sheet 9 by ejecting ink onto the sheet 9. The sheet 9 is a sheet-type image forming medium such as paper or a resin film.

It is noted that the inkjet recording apparatus 10 may be a facsimile apparatus, a copying machine, a multifunction peripheral, or the like that is capable of executing the print processing using the inkjet system.

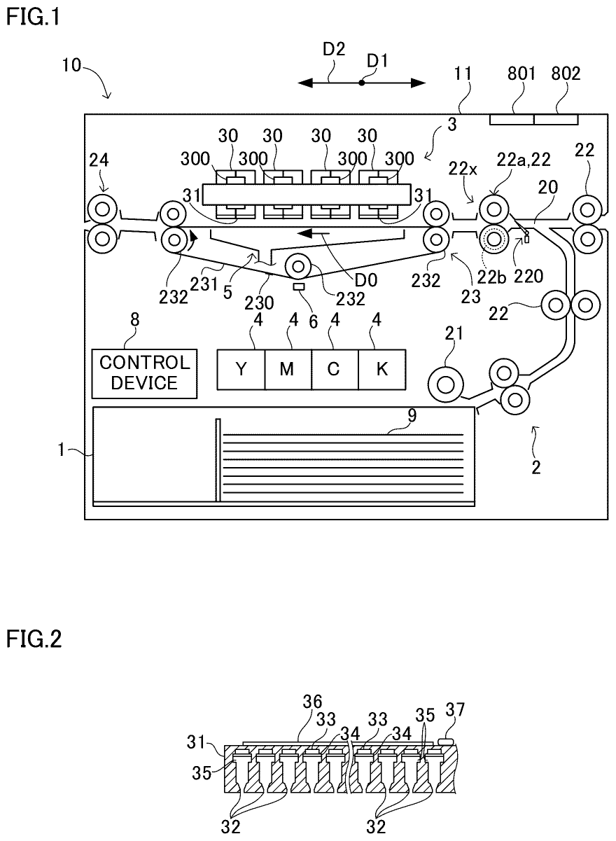

As shown in FIG. 1, the inkjet recording apparatus 10 includes a sheet storing portion 1, a sheet conveying device 2, a print portion 3, a plurality of ink supplying portions 4, a control device 8, and the like.

The sheet storing portion 1, the sheet conveying device 2, the print portion 3, the plurality of ink supplying portions 4, and the control device 8 are arranged in a main housing 11. The inkjet recording apparatus 10 further includes an operation device 801 and a display device 802.

The sheet conveying device 2 feeds the sheets 9 stored in the sheet storing portion 1 one by one to a conveying path 20, and further conveys the sheet 9 along the conveying path 20.

The sheet conveying device 2 includes a sheet feed mechanism 21, a plurality of conveying roller pairs 22, a belt conveying device 23, a discharge roller pair 24, and the like. The sheet feed mechanism 21 feeds the sheet 9 from the sheet storing portion 1 to the conveying path 20. The plurality of conveying roller pairs 22 convey the sheet 9 along the conveying path 20 and further convey the sheet 9 to the belt conveying device 23.

The plurality of conveying roller pairs 22 may, in some cases, convey cut sheets supplied from a roll paper supplying device connected at a position preceding the inkjet recording apparatus 10 to the belt conveying device 23. The roll paper supplying device reels out roll paper wound in a roll and cuts the reeled-out paper at a preset length to generate the cut sheets. In addition, the roll paper supplying device supplies the cut sheets to the inkjet recording apparatus 10. The cut sheet is an example of the sheet 9.

The belt conveying device 23 is arranged below the print portion 3. The belt conveying device 23 includes an endless conveying belt 231 and a plurality of tension rollers 232.

The plurality of tension rollers 232 rotatably support the conveying belt 231. As a motor (not shown) causes one of the plurality of tension rollers 232 to rotate, the conveying belt 231 rotates. The belt conveying device 23 causes the conveying belt 231 to rotate, to thus convey the sheet 9 in a conveying direction DO on the conveying belt 231.

A direction orthogonal to the conveying direction DO is a main scanning direction D1, and a direction along the conveying direction DO is a sub-scanning direction D2 (see FIG. 1).

The plurality of conveying roller pairs 22 include a registration roller pair 22a arranged at a position preceding the belt conveying device 23. The registration roller pair 22a is arranged on an upstream side of the conveying direction DO with respect to the belt conveying device 23.

The sheet conveying device 2 includes a registration motor 22b that causes the registration roller pair 22a to rotate and a sheet detection device 220 arranged at a position preceding the registration roller pair 22a.

The registration roller pair 22a and the registration motor 22b constitute a preceding conveying device 22x that conveys the sheet 9 to the belt conveying device 23. The sheet detection device 220 detects the sheet 9 at a position on the upstream side of the conveying direction DO with respect to the registration roller pair 22a on the conveying path 20.

The preceding conveying device 22x is capable of conveying the sheet 9 to the belt conveying device 23 at an arbitrary timing after temporarily stopping the conveyance of the sheet 9 in accordance with a detection timing of the sheet 9 by the sheet detection device 220.

The print portion 3 forms an image on the sheet 9 by ejecting ink of a plurality of colors toward the sheet 9 conveyed by the belt conveying device 23.

The discharge roller pair 24 is arranged more on a downstream side of the conveying direction DO than the belt conveying device 23. The discharge roller pair 24 discharges the sheet 9 on which an image has been formed to the outside of the main housing 11. For example, the discharge roller pair 24 feeds the sheet 9 from the main housing 11 to a discharge tray or a subsequent device arranged next to the inkjet recording apparatus 10.

The plurality of ink supplying portions 4 each supply ink of a predetermined color to the print portion 3. The colors of the ink are, for example, black, cyan, magenta, and yellow. In this case, the inkjet recording apparatus 10 includes four ink supplying portions 4.

### [Print Portion 3]

The print portion 3 forms an image on the sheet 9 by ejecting the ink onto the sheet 9 conveyed by the belt conveying device 23.

The print portion 3 includes a plurality of nozzle units 30 respectively corresponding to the plurality of ink colors. The plurality of ink supplying portions 4 respectively supply the ink to the plurality of nozzle units 30.

In the present embodiment, the print portion 3 includes four nozzle units 30 respectively corresponding to the ink of black, cyan, magenta, and yellow.

Each of the nozzle units 30 includes an ink ejection portion 31 (see FIG. 1). The ink ejection portion 31 includes a plurality of nozzles 32 arranged opposed to an upper surface of the conveying belt 231 (see FIG. 2). The plurality of nozzles 32 eject the ink onto the sheet 9 to thus form an image on the sheet 9.

Further, the ink ejection portion 31 includes a plurality of piezoelectric elements 33, a plurality of pressure chambers 35, and a plurality of vibration plates 34. The plurality of piezoelectric elements 33, the plurality of pressure chambers 35, and the plurality of vibration plates 34 are respectively provided in correspondence with the plurality of nozzles 32.

The plurality of pressure chambers 35 are respectively in communication with the plurality of nozzles 32. The plurality of pressure chambers 35 respectively form paths for the ink to be supplied to the plurality of nozzles 32. The ink inside the plurality of pressure chambers 35 is supplied to the plurality of nozzles 32.

The plurality of vibration plates 34 each form a part of a partition wall of the plurality of pressure chambers 35. Each of the piezoelectric elements 33 is supplied with a drive signal so that the ink inside the pressure chambers 35 is pressurized via each of the vibration plates 34.

The drive signal is a signal having a waveform adjusted in accordance with a size of an ink droplet to be ejected. The drive signal is supplied from the control device 8 to each of the piezoelectric elements 33.

In other words, each of the piezoelectric elements 33 is supplied with the drive signal from the control device 8 so as to pressurize the ink to be supplied to the plurality of nozzles 32.

The piezoelectric element 33 supplied with the drive signal vibrates by energy with which the ink is ejected from the corresponding nozzle 32. In other words, by being supplied with the drive signal, each of the piezoelectric elements 33 pressurizes the ink in the pressure chamber 35 at a level at which the ink is ejected from the nozzle 32.

The ink pressurized by the piezoelectric element 33 supplied with the drive signal flows into the corresponding nozzle 32 from the pressure chamber 35 and is further ejected from the nozzle 32.

In other words, the plurality of piezoelectric elements 33 pressurize the ink to be supplied to the plurality of nozzles 32 to cause the ink to be ejected from the plurality of nozzles 32. Each of the nozzle units 30 is capable of executing the print processing by ejecting the ink onto the sheet 9 conveyed on the conveying belt 231.

Each of the nozzle units 30 further includes a unit heater 36 and a unit temperature sensor 37 (see FIG. 2). The unit heater 36 and the unit temperature sensor 37 are arranged in the ink ejection portion 31 of each of the nozzle units 30.

In other words, the inkjet recording apparatus 10 includes a plurality of unit heaters 36 and a plurality of unit temperature sensors 37 respectively corresponding to the plurality of nozzle units 30.

The unit heater 36 heats the ink ejection portion 31. The unit temperature sensor 37 detects a temperature of the ink ejection portion 31. In other words, the unit temperature sensor 37 detects a temperature of the nozzle unit 30 on the nozzle unit 30. The unit temperature sensor 37 is, for example, a thermistor.

The unit temperature sensor 37 is an example of an internal temperature sensor which detects an internal temperature of the inkjet recording apparatus 10.

When the temperature of the ink decreases, viscosity of the ink increases. When the viscosity of the ink to be supplied to each of the nozzles 32 is high, ejection performance of the ink from each of the nozzles 32 at a time each of the piezoelectric elements 33 operates deteriorates.

The unit heater 36 heats the ink in the ink ejection portion 31 to maintain the viscosity of the ink to be supplied to each of the nozzles 32 in an appropriate state.

By the unit heater 36 heating the ink of the ink ejection portion 31 before the print processing is started, a first print time is shortened. The first print time is a time required for the inkjet recording apparatus 10 to start the print processing since receiving a print request.

Power to be supplied to the unit heater 36 is adjusted by feedback control that is based on a detection temperature obtained by the unit temperature sensor 37.

The operation device 801 accepts operations of people. For example, the operation device 801 includes one or both of a touch panel and one or more operation buttons. The display device 802 is capable of displaying various types of information. For example, the display device 802 is a panel display device such as a liquid crystal panel unit.

### [Control Device 8]

The control device 8 executes various types of data processing and control of devices provided in the inkjet recording apparatus 10.

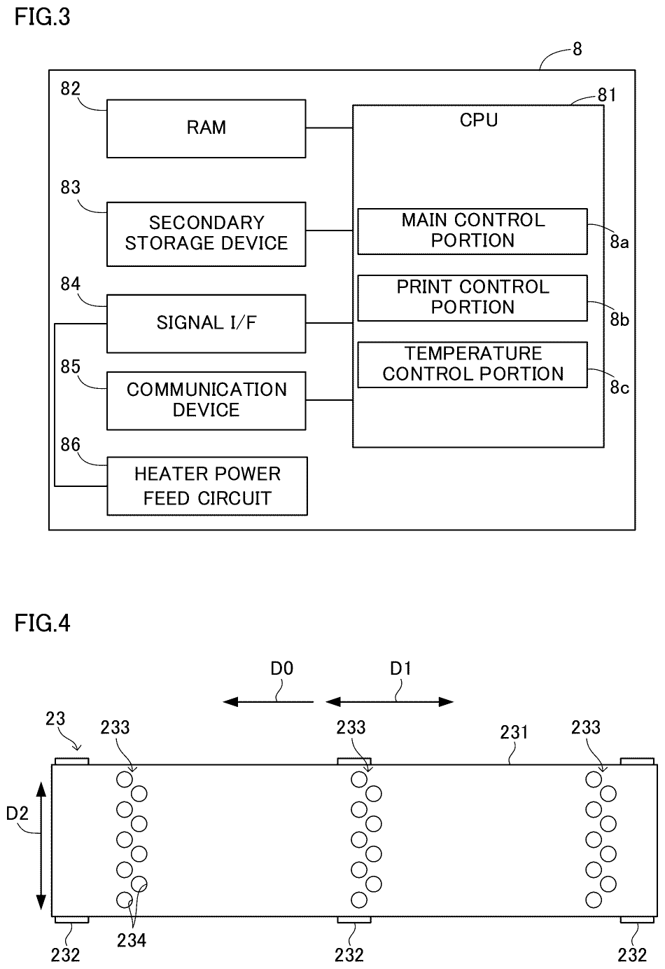

As shown in FIG. 3, the control device 8 includes peripheral devices such as a CPU (Central Processing Unit) 81, a RAM (Random Access Memory) 82, a secondary storage device 83, and a signal interface 84. In addition, the control device 8 includes a communication device 85 and a heater power feed circuit 86.

The CPU 81 is a processor which executes computer programs to thus execute various types data processing and control. The CPU 81 is an example of a processor which controls the plurality of piezoelectric elements 33 and other devices.

The RAM 82 is a volatile computer-readable storage device. The RAM 82 primarily stores the computer programs to be executed by the CPU 81 and data to be output and referenced by the CPU 81 during the process of executing various types of processing.

The secondary storage device 83 is a nonvolatile computer-readable storage device. The secondary storage device 83 is capable of storing and updating the computer programs and various types of data. For example, one or both of a flash memory and a hard disk drive is/are adopted as the secondary storage device 83.

The signal interface 84 converts signals output from various sensors into digital data and transmits the digital data obtained by the conversion to the CPU 81. In addition, the signal interface 84 converts control instructions output by the CPU 81 into control signals, and transmits the control signals to a device to be controlled.

The communication device 85 is capable of communicating with a host apparatus (not shown) and other apparatuses. The host apparatus is an information processing apparatus such as a personal computer or a smartphone that is operated by a user.

For example, the CPU 81 receives a print job from the host apparatus via the communication device 85. The print portion 3 forms an image specified by the print job on the sheet 9.

The heater power feed circuit 86 supplies power to the unit heater 36 in an amount corresponding to an input power instruction.

The CPU 81 includes a plurality of processing modules that are realized by executing the computer programs. The plurality of processing modules include a main control portion 8a, a print control portion 8b, a temperature control portion 8c, and the like.

The main control portion 8a executes control for causing various types of processing to be started in accordance with processing requests input via the operation device 801 or the communication device 85, control of the display device 802, and the like. The processing requests include a print request for requesting execution of the print processing.

The print control portion 8b controls the sheet conveying device 2. In other words, the print control portion 8b controls supply of the sheet 9 by the sheet feed mechanism 21, conveyance of the sheet 9 by the plurality of conveying roller pairs 22 and the belt conveying device 23, and discharge of the sheet 9 by the discharge roller pair 24.

In addition, the print control portion 8b causes the print portion 3 to execute the print processing in sync with the conveyance of the sheet 9 by the sheet conveying device 2. The print control portion 8b controls the plurality of piezoelectric elements 33 to cause the print portion 3 to execute the print processing.

The temperature control portion 8c outputs a signal of the power instruction to the heater power feed circuit 86 via the signal interface 84, to thus control power to be supplied to the unit heater 36.

Further, each of the nozzle units 30 includes a drive circuit 300 which supplies the drive signal to each of the piezoelectric elements 33 (see FIG. 1).

The drive circuit 300 outputs the drive signal to each of the piezoelectric elements 33 according to an input signal of a pressurization instruction. By supplying the drive signal to each of the plurality of piezoelectric elements 33 from the drive circuit 300, each of the nozzle units 30 forms an image on the sheet 9 by the ink ejected from the plurality of nozzles 32.

The print control portion 8b outputs the signal of the pressurization instruction that corresponds to the size of the ink droplet to be discharged from each of the nozzles 32 to the drive circuit 300 via the signal interface 84. The print control portion 8b controls each of the piezoelectric elements 33 via the drive circuit 300.

Incidentally, during a period from when the print request occurs to when the print processing ends, appropriately maintaining the viscosity of the ink to be supplied to each of the nozzles 32 so as to prevent each of the nozzles 32 from being clogged is being demanded.

The print control portion 8b executes first opening flushing control, sheet flushing control, and second opening flushing control to be described later (see FIG. 5 to FIG. 7). The first opening flushing control, the sheet flushing control, and the second opening flushing control include processing for preventing each of the nozzles 32 from being clogged during the period from when the print request occurs to when the print processing ends.

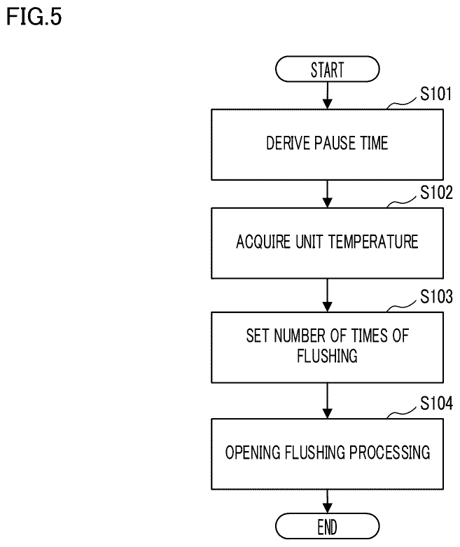

In the conveying belt 231 of the belt conveying device 23, a plurality of opening portions 233 each constituted of one or more through-holes 234 are formed with intervals in a circumferential direction (see FIG. 4).

In a case where the ink is ejected from the plurality of nozzles 32 when the opening portions 233 pass through the print position opposing the ink ejection portion 31 of each of the nozzle units 30, the ejected ink passes through each of the opening portions 233.

The inkjet recording apparatus 10 further includes an ink recovery mechanism 5 which recovers the ink that has passed through each of the opening portions 233 of the conveying belt 231 (see FIG. 1).

For example, the ink recovery mechanism 5 includes an ink tray, a pump, an ink tank, and the like. The ink tray receives the ink that has passed through each of the opening portions 233. The pump sucks in the ink that has dropped into the ink tray using a tube to convey the ink. The ink tank accumulates therein the ink conveyed by the pump.

The inkjet recording apparatus 10 further includes a belt position sensor 6 which is used to detect a rotational position of the conveying belt 231. For example, the belt position sensor 6 is a photosensor, a microswitch, or the like that detects a to-be-detected portion 230 formed in the conveying belt 231. The photosensor is a reflective or transmissive sensor.

When the belt position sensor 6 is the photosensor, the to-be-detected portion 230 is a through-hole, a mirror surface portion, or the like formed in the conveying belt 231. Meanwhile, when the belt position sensor 6 is the microswitch, the to-be-detected portion 230 is a protrusion portion or the like formed in the conveying belt 231.

The print control portion 8b counts a belt rotation time that is a rotation time of the conveying belt 231 using a time point at which the to-be-detected portion 230 is detected by the belt position sensor 6 as the point of origin.

In addition, the print control portion 8b specifies a base end passage timing in accordance with the belt rotation time.

The base end passage timing is a timing at which each of the opening portions 233 passes through a base end of an area for conveying the sheet 9 on the conveying belt 231. The base end is a conveyance start position of the sheet 9 on the conveying belt 231.

The print control portion 8b controls the conveyance of the sheet 9 to the belt conveying device 23 such that a tip end of the sheet 9 reaches the base end on the conveying belt 231 subsequent to the base end passage timing. By controlling the preceding conveying device 22x, the print control portion 8b controls the conveyance of the sheet 9 to the belt conveying device 23.

Further, the print control portion 8b specifies a nozzle passage timing in accordance with the belt rotation time. The nozzle passage timing is a timing at which each of the opening portions 233 passes through the print position opposing the ink ejection portion 31 of each of the nozzle units 30.

Herein, of the plurality of nozzle units 30, one or a plurality of nozzle units 30 that opposes/oppose any of the plurality of opening portions 233 at the nozzle passage timing will be referred to as a target nozzle unit. The print control portion 8b causes the target nozzle unit to execute opening flushing processing at the nozzle passage timing.

The opening flushing processing is processing of ejecting the ink toward each of the opening portions 233 in an area with no sheet 9 on the conveying belt 231. The opening flushing processing is called, for example, line flushing processing or the like.

In addition, the print control portion 8b can also cause each of the nozzle units 30 to execute sheet flushing processing when the sheet 9 is being conveyed by the belt conveying device 23.

The sheet flushing processing is processing of ejecting the ink onto a non-drawing area that is an area to be not drawn in the sheet 9 in parallel with the print processing with respect to the sheet 9. The sheet flushing processing is called, for example, in-sheet flushing processing, in-paper flushing processing, or the like.

The print control portion 8b causes each of the nozzle units 30 to execute the sheet flushing processing so that a plurality of ink points are dispersedly formed across a wide range of the sheet 9. Thus, the plurality of ink points are formed on the sheet 9 so as not to stick out as much as possible.

By executing the opening flushing processing or the sheet flushing processing, the ink having high viscosity is ejected and the ink is newly filled in the plurality of nozzles 32 of each of the nozzle units 30. As a result, the viscosity of the ink in the plurality of nozzles 32 is maintained appropriately.

It is noted that the inkjet recording apparatus 10 may include a rotary encoder which detects a rotational position of one of the plurality of tension rollers 232. In this case, the print control portion 8b counts the number of encoder pulses which is the number of output pulses of the rotary encoder using the time point at which the to-be-detected portion 230 is detected by the belt position sensor 6 as the point of origin.

The print control portion 8b can specify the base end passage timing in accordance with the number of encoder pulses. Similarly, the print control portion 8b can specify the nozzle passage timing in accordance with the number of encoder pulses.

The first opening flushing control and the second opening flushing control are processing of causing each of the nozzle units 30 to execute the opening flushing processing. The sheet flushing control is processing of causing each of the nozzle units 30 to execute the sheet flushing processing.

After receiving the print request, the print control portion 8b executes the first opening flushing control before causing the print portion 3 to start the print processing corresponding to the print request. In addition, the print control portion 8b executes the sheet flushing control in parallel with the control to cause the print portion 3 to execute the print processing.

Further, the print control portion 8b executes, for each print processing with respect to a single sheet 9, the second opening flushing control before the print processing with respect to the next single sheet 9.

The first opening flushing control, the sheet flushing control, and the second opening flushing control are each an example of processing for realizing an inkjet control method for controlling the inkjet recording apparatus 10. The CPU 81 including the print control portion 8b is an example of a processor which realizes the inkjet control method.

### [First Opening Flushing Control]

Hereinafter, exemplary procedures of the first opening flushing control will be described with reference to the flowchart shown in FIG. 5.

When the print request is received via the operation device 801 or the communication device 85, the main control portion 8a causes the print control portion 8b to execute the first opening flushing control.

In descriptions below, S101, S102, . . . represent identification codes of a plurality of steps in the first opening flushing control. In the first opening flushing control, processing of Step S101 is executed first.

### <Step S101>

In Step S101, the print control portion 8b derives a pause time of each of the nozzle units 30. The pause time is a duration time of an ink non-ejection state of each of the nozzle units 30 up to a time point at which the print control portion 8b receives the print request.

For example, the print control portion 8b records, in the secondary storage device 83, information on a print end time which is a time at which the print processing corresponding to the print request is ended. In addition, the print control portion 8b derives a difference between a time at which the print request has been received and the print end time recorded in the secondary storage device 83 as the pause time.

After executing the processing of Step S101, the print control portion 8b executes processing of Step S102.

### <Step S102>

In Step S102, the print control portion 8b acquires a unit temperature which is a detection temperature of the unit temperature sensor 37 of each of the nozzle units 30.

After executing the processing of Step S102, the print control portion 8b executes processing of Step S103.

### <Step S103>

In Step S103, the print control portion 8b sets the number of times of flushing corresponding to the pause time and the unit temperature.

The print control portion 8b sets the number of times of flushing to be larger in a case where the pause time is long than in a case where the pause time is short. Moreover, the print control portion 8b sets the number of times of flushing to be larger in a case where the unit temperature is low than in a case where the unit temperature is high.

For example, a reference setting table that shows a correspondence relationship between the pause time and the reference number of times in a case where the unit temperature is a reference temperature is set in advance. The print control portion 8b derives the reference number of times by applying the pause time to the reference setting table.

In addition, the print control portion 8b corrects the reference number of times in accordance with a difference between the unit temperature and the reference temperature, and sets the corrected number of times as the number of times of flushing. In this case, when the unit temperature is higher than the reference temperature, the print control portion 8b corrects the reference number of times in a decreasing direction. On the other hand, when the unit temperature is lower than the reference temperature, the print control portion 8b corrects the reference number of times in an increasing direction.

After executing the processing of Step S103, the print control portion 8b executes processing of Step S104.

It is noted that the inkjet recording apparatus 10 may include a peripheral temperature sensor which detects a peripheral temperature of the plurality of nozzle units 30. In this case, a detection temperature of the peripheral temperature sensor may be used to set the number of times of flushing in place of the unit temperature. The peripheral temperature sensor is an example of the internal temperature sensor.

After executing the processing of Step S103, the print control portion 8b executes processing of Step S104.

### <Step S104>

In Step S104, the print control portion 8b causes each of the nozzle units 30 to execute the opening flushing processing by the number of times of flushing set in Step S103.

For example, the print control portion 8b causes the belt conveying device 23 to operate and causes each of the nozzle units 30 to execute the opening flushing processing by the number of times of flushing under the situation where the belt conveying device 23 is operating. In this case, the print control portion 8b causes each of the nozzle units 30 to execute the opening flushing processing at each of the nozzle passage timings corresponding to the number of times of flushing.

Further, after causing the belt conveying device 23 to operate, the print control portion 8b may stop the belt conveying device 23 at the nozzle passage timing. In this case, the print control portion 8b causes each of the nozzle units 30 to execute the opening flushing processing by the number of times of flushing under the situation where the belt conveying device 23 is stopped.

After executing the processing of Step S104, the print control portion 8b ends the first opening flushing control.

Subsequent to the first opening flushing control, the print control portion 8b causes the sheet conveying device 2 and the print portion 3 to respectively execute the conveyance of the sheet 9 and the print processing that correspond to the print request.

In addition, the print control portion 8b executes the sheet flushing control in parallel with the print processing.

### [Sheet Flushing Control]

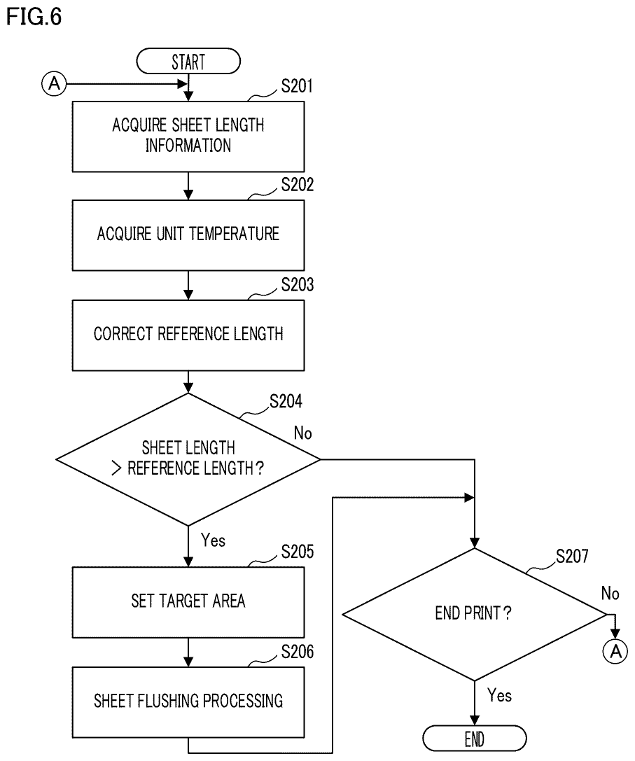

Next, exemplary procedures of the sheet flushing control will be described with reference to the flowchart shown in FIG. 6.

As described above, the print control portion 8b executes the sheet flushing control in parallel with the control for causing the print portion 3 to execute the print processing.

In descriptions below, S201, S202, . . . represent identification codes of a plurality of steps in the sheet flushing control. In the sheet flushing control, processing of Step S201 is executed first.

### <Step S201>

In Step S201, the print control portion 8b acquires sheet length information expressing a length of a target sheet in the conveying direction DO. The target sheet in the sheet flushing control is the sheet 9 that becomes a target of the conveyance by the belt conveying device 23.

For example, the print control portion 8b acquires sheet information included in the print request as the sheet length information. The sheet information includes sheet size information expressing a longitudinal size and lateral size of the target sheet and orientation information expressing an orientation of the target sheet. The size information may alternatively be information expressing a standard size of the sheet 9.

In the case described above, the print control portion 8b specifies one of the longitudinal size information and lateral size information of the target sheet as the sheet length information in accordance with the orientation information.

After executing the processing of Step S201, the print control portion 8b executes processing of Step S202.

### <Step S202>

In Step S202, the print control portion 8b acquires the unit temperature of each of the nozzle units 30.

After executing the processing of Step S202, the print control portion 8b executes processing of Step S203.

### <Step S203>

In Step S203, the print control portion 8b corrects a preset reference length based on the unit temperature.

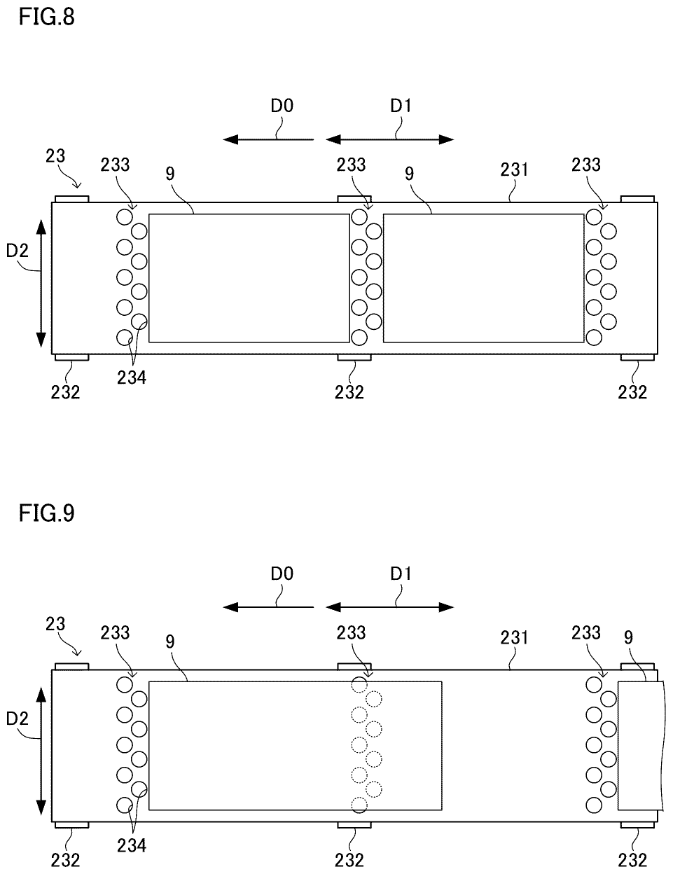

The reference length is a length to be compared with the length of the sheet length information. For example, the reference length before the correction is roughly an interval between the plurality of opening portions 233 on the conveying belt 231. FIG. 8 shows a state where the sheet 9 having the reference length before the correction is conveyed by the belt conveying device 23. FIG. 9 shows a state where the sheet 9 longer than the reference length before the correction is conveyed by the belt conveying device 23.

When the sheet 9 having the reference length before the correction is conveyed under the situation where the unit temperature is the reference temperature, the viscosity of the ink in the plurality of nozzles 32 is maintained appropriately only by the opening flushing processing.

When the unit temperature is higher than a reference temperature range that uses the reference temperature as a reference, the print control portion 8b corrects the reference length to become longer. On the other hand, when the unit temperature is lower than the reference temperature range, the print control portion 8b sets the reference length to 0.

After executing the processing of Step S203, the print control portion 8b executes processing of Step S204.

It is noted that when the inkjet recording apparatus 10 includes the peripheral temperature sensor, the detection temperature of the peripheral temperature sensor may be used to correct the reference length in place of the unit temperature.

### <Step S204>

In Step S204, the print control portion 8b compares the length of the sheet length information and the reference length. The print control portion 8b selects next processing in accordance with whether or not the length of the sheet length information is larger than the reference length.

When the length of the sheet length information is not larger than the reference length, the print control portion 8b executes processing of Step S207. In this case, processing of Step S205 and Step S206 is not executed. On the other hand, when the length of the sheet length information is larger than the reference length, the print control portion 8b executes the processing of Step S205.

### <Step S205>

In Step S205, the print control portion 8b sets a target area to become a target of the sheet flushing processing out of the entire area of the target sheet in the conveying direction DO in accordance with the sheet length information.

The target area is a series of areas from a rear end to a tip end side in the target sheet. The target area is a partial area or entire area of the target sheet.

For example, the print control portion 8b sets the target area to be longer in the conveying direction DO in the case where the length of the sheet length information is long than in the case where the length of the sheet length information is short.

After executing the processing of Step S205, the print control portion 8b executes processing of Step S206.

### <Step S206>

In Step S206, the print control portion 8b causes each of the nozzle units 30 to execute the sheet flushing processing.

In Step S206, the print control portion 8b causes each of the nozzle units 30 to execute the sheet flushing processing in parallel with the print processing corresponding to the print request.

In Step S206, the print control portion 8b causes each of the nozzle units 30 to execute the sheet flushing processing that is directed toward the target area of the target sheet.

After executing the processing of Step S206, the print control portion 8b executes processing of Step S207.

### <Step S207>

In Step S207, the print control portion 8b selects next processing in accordance with whether or not the print processing corresponding to the print request is ended.

When the print processing corresponding to the print request is not ended, the print control portion 8b executes the processing of Step S201 and the subsequent steps for the next target sheet. On the other hand, when the print processing corresponding to the print request is ended, the print control portion 8b ends the sheet flushing control.

As described above, in Step S204 to Step 206, the print control portion 8b selectively executes one of first unit control and second unit control for each of the sheets 9. The first unit control is processing of causing each of the nozzle units 30 to execute the sheet flushing processing. The second unit control is processing in which each of the nozzle units 30 is not caused to execute the sheet flushing processing.

### [Second Opening Flushing Control]

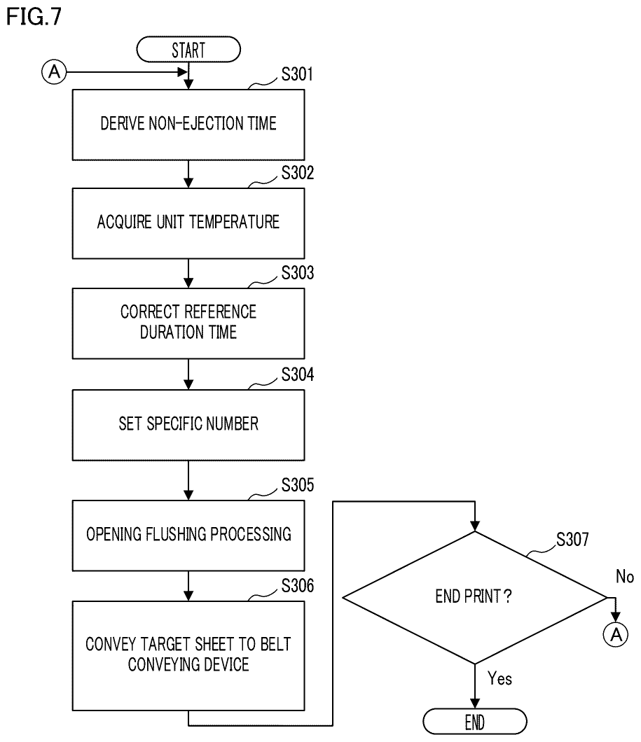

Next, exemplary procedures of the second opening flushing control will be described with reference to the flowchart shown in FIG. 7.

As described above, for each print processing with respect to a single sheet 9, the print control portion 8b executes the second opening flushing control before the print processing with respect to the next single sheet 9.

In descriptions below, S301, S302, . . . represent identification codes of a plurality of steps in the second opening flushing control. In the second opening flushing control, processing of Step S301 is executed first.

### <Step S301>

In Step S301, the print control portion 8b derives a non-ejection time corresponding to each of the nozzle units 30 during a print period for a previous sheet that is one sheet before the target sheet.

The target sheet in the second opening flushing control is the sheet 9 to become a target of the conveyance by the preceding conveying device 22x. The non-ejection time is a duration time of an ink non-ejection state of each of the plurality of nozzles 32 from a start time point or middle of the print processing for the previous sheet to an end time point.

For example, the print control portion 8b derives a plurality of duration times of the ink non-ejection state that correspond to the plurality of nozzles 32 in each of the nozzle units 30, and derives a representative value of the plurality of duration times as the non-ejection time of each of the nozzle units 30.

For example, a maximum value of the plurality of duration times in each of the nozzle units 30 is derived as the non-ejection time of each of the nozzle units 30.

After executing the processing of Step S301, the print control portion 8b executes processing of Step S302.

### <Step S302>

In Step S302, the print control portion 8b acquires the unit temperature of each of the nozzle units 30.

After executing the processing of Step S302, the print control portion 8b executes processing of Step S303.

### <Step S303>

In Step S303, the print control portion 8b corrects a preset reference duration time based on the unit temperature. The reference duration time is a time to be compared with the non-ejection time.

When the non-ejection time does not exceed the reference duration time under the situation where the unit temperature is the reference temperature, the viscosity of the ink in each of the nozzles 32 is maintained appropriately only by the opening flushing processing performed once.

When the unit temperature is higher than the reference temperature range that uses the reference temperature as a reference, the print control portion 8b corrects the reference duration time to become longer. On the other hand, when the unit temperature is lower than the reference temperature range, the print control portion 8b corrects the reference duration time to become shorter.

After executing the processing of Step S303, the print control portion 8b executes processing of Step S304.

It is noted that when the inkjet recording apparatus 10 includes the peripheral temperature sensor, the detection temperature of the peripheral temperature sensor may be used to correct the reference duration time in place of the unit temperature.

### <Step S304>

In Step S304, the print control portion 8b sets a specific number by comparing the non-ejection time derived in Step S301 and the reference duration time. The specific number is an integer of 1 or more.

For example, the print control portion 8b sets the specific number to 1 when the non-ejection time of each of the nozzle units 30 does not exceed the reference duration time.

On the other hand, the print control portion 8b sets the specific number to 2 when the non-ejection time of each of the nozzle units 30 exceeds the reference duration time. It is noted that when the non-ejection time of each of the nozzle units 30 exceeds the reference duration time, the print control portion 8b may set the specific number to a number of 3 or more in accordance with the non-ejection time.

After executing the processing of Step S304, the print control portion 8b executes processing of Step S305.

### <Step S305>

In Step S305, the print control portion 8b causes each of the nozzle units 30 to execute the opening flushing processing the number of times corresponding to the specific number set in Step S304.

Herein, of the plurality of opening portions 233 of the conveying belt 231, one or a plurality of opening portions 233 that passes/pass through the print position subsequent to the previous sheet will be referred to as a subsequent opening portion.

In Step S305, the print control portion 8b causes each of the nozzle units 30 to execute the opening flushing processing of the specific number of times, that is directed toward the specific number of subsequent opening portions.

For example, when the specific number is 1, the print control portion 8b causes each of the nozzle units 30 to execute the opening flushing processing once toward one subsequent opening portion. When the specific number is 2, the print control portion 8b causes each of the nozzle units 30 to execute the opening flushing processing twice toward two subsequent opening portions.

After executing the processing of Step S305, the print control portion 8b executes processing of Step S306.

### <Step S306>

In Step S306, the print control portion 8b causes the preceding conveying device 22x to execute processing of conveying the target sheet to the belt conveying device 23 at a timing subsequent to the specific number of subsequent opening portions.

In other words, the print control portion 8b causes the preceding conveying device 22x to execute the processing of conveying the target sheet to the belt conveying device 23 at a timing at which the specific number of subsequent opening portions that have become targets of the opening flushing processing have passed through the base end of the conveying belt 231.

For example, when the specific number is 1, the print control portion 8b causes the preceding conveying device 22x to execute the processing of conveying the target sheet to the belt conveying device 23 at a timing at which one subsequent opening portion intervenes between the target sheet and the previous sheet.

Further, when the specific number is 2, the print control portion 8b causes the preceding conveying device 22x to execute the processing of conveying the target sheet to the belt conveying device 23 at a timing at which two subsequent opening portions intervene between the target sheet and the previous sheet.

After executing the processing of Step S306, the print control portion 8b executes processing of Step S307.

### <Step S307>

In Step S307, the print control portion 8b selects next processing in accordance with whether or not the print processing corresponding to the print request is ended.

When the print processing corresponding to the print request is not ended, the print control portion 8b executes the processing of Step S301 and the subsequent steps for the next target sheet.

In other words, the print control portion 8b executes the processing of Step S301 to Step S306 for each of the target sheets to become a target of the conveyance by the preceding conveying device 22x. The non-ejection time of each of the nozzle units 30 is an example of an ink ejection performance of each of the nozzle units 30 at a time a previous sheet is conveyed by the belt conveying device 23.

On the other hand, when the print processing corresponding to the print request is ended, the print control portion 8b ends the second opening flushing control.

By executing each of the first opening flushing control, the sheet flushing control, and the second opening flushing control, the viscosity of the ink to be supplied to each of the nozzles 32 in each of the nozzle units 30 is maintained appropriately during the period from when the print request occurs to when the print processing ends. As a result, each of the nozzles 32 is prevented from being clogged. [0182][First modified example]

Next, a first modified example of the inkjet recording apparatus 10 will be described.

In the present modified example, the inkjet recording apparatus 10 includes a humidity sensor which detects a humidity inside the main housing 11. The humidity sensor is an example of an internal humidity sensor which detects an internal humidity of the inkjet recording apparatus 10.

In Step S202 of the sheet flushing control, the print control portion 8b in the present modified example acquires an environmental humidity which is a detection humidity of the humidity sensor.

In addition, in Step S203 of the sheet flushing control, the print control portion 8b in the present modified example corrects the reference length in accordance with the environmental humidity.

For example, the print control portion 8b in the present modified example corrects the reference length to become longer when the environmental humidity is higher than a reference humidity range that uses a reference humidity as a reference. On the other hand, when the environmental humidity is lower than the reference humidity range, the print control portion 8b sets the reference length to 0.

In Step S302 of the second opening flushing control, the print control portion 8b in the present modified example acquires the environmental humidity.

In addition, in Step S303 of the second opening flushing control, the print control portion 8b in the present modified example corrects the reference duration time in accordance with the environmental humidity.

For example, when the environmental humidity is higher than the reference humidity range, the print control portion 8b in the present modified example corrects the reference duration time to become longer. On the other hand, when the environmental humidity is lower than the reference humidity range, the print control portion 8b corrects the reference duration time to become shorter.

In the present modified example, the print control portion 8b may execute both of the correction that is based on the unit temperature and the correction that is based on the environmental humidity regarding the corrections of the reference length and the reference duration time. Alternatively, the print control portion 8b may execute only one of the correction that is based on the unit temperature and the correction that is based on the environmental humidity.

### Second Modified Example

Next, a second modified example of the inkjet recording apparatus 10 will be described.

In the present modified example, the main control portion 8a is capable of setting one of two candidate modes as an operation mode in accordance with mode setting information input via the operation device 801 or the communication device 85.

The two candidate modes include a first operation mode in which one or both of the opening flushing processing and the sheet flushing processing is/are automatically selected as the target flushing processing, and a second operation mode in which only the opening flushing processing is preferentially selected as the target flushing processing.

In the present modified example, when the first operation mode is set as the operation mode, the print control portion 8b executes the sheet flushing control by the procedures shown in FIG. 5.

When the second operation mode is set as the operation mode, the print control portion 8b does not execute the sheet flushing control.

Also when the present modified example is adopted, effects similar to those of the case where the embodiment above is adopted can be obtained. It is noted that the present modified example may be applied to the first modified example.

### Third Modified Example

Next, a third modified example of the inkjet recording apparatus 10 will be described.

In the second opening flushing control, the print control portion 8b in the present modified example executes specific number setting processing described below in place of the processing of Step S301 to Step S304.

In the present modified example, the specific number setting processing involves setting the specific number in accordance with whether or not the sheet flushing processing with respect to a previous sheet has been executed.

For example, when the sheet flushing processing with respect to a previous sheet has been executed, the print control portion 8b sets the specific number to 1. Further, when the sheet flushing processing with respect to a previous sheet has not been executed, the print control portion 8b sets the specific number to 2.

In the present modified example, whether or not the sheet flushing processing with respect to a previous sheet has been executed is an example of the ink ejection performance of each of the nozzle units 30 obtained at a time the previous sheet is conveyed by the belt conveying device 23.

Also when the present modified example is adopted, effects similar to those of the case where the embodiment above is adopted can be obtained. It is noted that the present modified example may be applied to the first modified example or the second modified example.

[Notes of disclosure] Hereinafter, a general outline of the invention extracted from the embodiment described above will be noted. It is noted that the respective configurations and processing functions described in the notes below can be sorted and arbitrarily combined as appropriate.

### <Note 1>

An inkjet control method for controlling an inkjet recording apparatus including
a belt conveying device which includes an endless conveying belt in which a plurality of opening portions each constituted of one or more through-holes are formed with intervals in a circumferential direction, and conveys a sheet on the conveying belt by causing the conveying belt to rotate,
a preceding conveying device which conveys the sheet to the belt conveying device, and
a nozzle unit which includes a plurality of nozzles arranged opposed to a print position on an upper surface of the conveying belt and a plurality of piezoelectric elements which pressurize ink to be supplied to the plurality of nozzles to cause the ink to be ejected from the plurality of nozzles, and is capable of executing print processing for forming an image on the sheet by ejecting the ink onto the sheet conveyed on the conveying belt, the inkjet control method including:
setting, by a processor, for each target sheet that becomes a target to be conveyed by the preceding conveying device, a specific number of 1 or more in accordance with an ink ejection performance of the nozzle unit obtained at a time a previous sheet that is one sheet before the target sheet is conveyed by the belt conveying device;
causing, by the processor, the nozzle unit to execute opening flushing processing for ejecting the ink toward the specific number of subsequent opening portions that pass through the print position subsequent to the previous sheet out of the plurality of opening portions; and
causing, by the processor, the preceding conveying device to execute processing of conveying the target sheet to the belt conveying device at a timing subsequent to the specific number of the subsequent opening portions.

### <Note 2>

The inkjet control method according to Note 1, in which
the processor sets the specific number in accordance with a duration time of an ink non-ejection state of each of the plurality of nozzles from a start time point or middle of the print processing for the previous sheet to an end time point.

### <Note 3>

The inkjet control method according to Note 2, in which
when the inkjet recording apparatus includes one or both of an internal temperature sensor which detects an internal temperature and an internal humidity sensor which detects an internal humidity,
the processor sets the specific number by correcting a reference time in accordance with a detection result of the one or both of the internal temperature sensor and the internal humidity sensor, and comparing the duration time of the ink non-ejection state and the corrected reference time.

### <Note 4>

The inkjet control method according to Note 1, further including:
selectively executing, by the processor, for each of the sheets, one of first unit control for causing the nozzle unit to execute sheet flushing processing for ejecting the ink onto a non-drawing area that is an area to be not drawn in the sheet in parallel with the print processing and a second unit control in which the nozzle unit is not caused to execute the sheet flushing processing, in which the processor sets the specific number in accordance with whether or not the sheet flushing processing with respect to the previous sheet has been executed.

### <Note 5>

An inkjet recording apparatus, including:
a belt conveying device which includes an endless conveying belt in which a plurality of opening portions each constituted of one or more through-holes are formed with intervals in a circumferential direction, and conveys a sheet on the conveying belt by causing the conveying belt to rotate;
a preceding conveying device which conveys the sheet to the belt conveying device;
a nozzle unit which includes a plurality of nozzles arranged opposed to a print position on an upper surface of the conveying belt and a plurality of piezoelectric elements which pressurize ink to be supplied to the plurality of nozzles to cause the ink to be ejected from the plurality of nozzles, and is capable of executing print processing for forming an image on the sheet by ejecting the ink onto the sheet conveyed on the conveying belt; and
a processor which realizes the inkjet control method according to any one of Notes 1 to 4.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An inkjet control method for controlling an inkjet recording apparatus including
a belt conveying device which includes an endless conveying belt in which a plurality of opening portions each constituted of one or more through-holes are formed with intervals in a circumferential direction, and conveys a sheet on the conveying belt by causing the conveying belt to rotate,
a preceding conveying device which conveys the sheet to the belt conveying device, and
a nozzle unit which includes a plurality of nozzles arranged opposed to a print position on an upper surface of the conveying belt and a plurality of piezoelectric elements which pressurize ink to be supplied to the plurality of nozzles to cause the ink to be ejected from the plurality of nozzles, and is capable of executing print processing for forming an image on the sheet by ejecting the ink onto the sheet conveyed on the conveying belt, the inkjet control method comprising:
setting, by a processor, for each target sheet that becomes a target to be conveyed by the preceding conveying device, a specific number of 1 or more in accordance with an ink ejection performance of the nozzle unit obtained at a time a previous sheet that is one sheet before the target sheet is conveyed by the belt conveying device;
causing, by the processor, the nozzle unit to execute opening flushing processing for ejecting the ink toward the specific number of subsequent opening portions that pass through the print position subsequent to the previous sheet out of the plurality of opening portions; and
causing, by the processor, the preceding conveying device to execute processing of conveying the target sheet to the belt conveying device at a timing subsequent to the specific number of the subsequent opening portions.

2. The inkjet control method according to claim 1, wherein
the processor sets the specific number in accordance with a duration time of an ink non-ejection state of each of the plurality of nozzles from a start time point or middle of the print processing for the previous sheet to an end time point.

3. The inkjet control method according to claim 2, wherein
when the inkjet recording apparatus includes one or both of an internal temperature sensor which detects an internal temperature and an internal humidity sensor which detects an internal humidity,
the processor sets the specific number by correcting a reference time in accordance with a detection result of the one or both of the internal temperature sensor and the internal humidity sensor, and comparing the duration time of the ink non-ejection state and the corrected reference time.

4. The inkjet control method according to claim 1, further comprising:
selectively executing, by the processor, for each of the sheets, one of first unit control for causing the nozzle unit to execute sheet flushing processing for ejecting the ink onto a non-drawing area that is an area to be not drawn in the sheet in parallel with the print processing and a second unit control in which the nozzle unit is not caused to execute the sheet flushing processing, wherein
the processor sets the specific number in accordance with whether or not the sheet flushing processing with respect to the previous sheet has been executed.

5. An inkjet recording apparatus, comprising:
a belt conveying device which includes an endless conveying belt in which a plurality of opening portions each constituted of one or more through-holes are formed with intervals in a circumferential direction, and conveys a sheet on the conveying belt by causing the conveying belt to rotate;
a preceding conveying device which conveys the sheet to the belt conveying device;
a nozzle unit which includes a plurality of nozzles arranged opposed to a print position on an upper surface of the conveying belt and a plurality of piezoelectric elements which pressurize ink to be supplied to the plurality of nozzles to cause the ink to be ejected from the plurality of nozzles, and is capable of executing print processing for forming an image on the sheet by ejecting the ink onto the sheet conveyed on the conveying belt; and
a processor which realizes the inkjet control method according to claim 1.
